(19) United States
(12) Patent Application Publication
(10) Pub. No.: US 2023/0351283 A1
(43) Pub. Date: Nov. 2, 2023

(54) INTELLIGENT PROJECT OPTIMIZATION EXPERIENCE

(71) Applicant: International Business Machines Corporation, Armonk, NY (US)

(72) Inventors: PEI HSIEH, New York, NY (US); Steve Rechtman, New York, NY (US); Christopher F. Ackermann, Fairfax, VA (US); Jennifer M. Hatfield, San Francisco, CA (US); Jeremy R. Fox, Georgetown, TX (US); Lucia Larise Stavarache, Columbus, OH (US); XINDELING PAN, San Francisco, CA (US)

(21) Appl. No.: 17/661,098

(22) Filed: Apr. 28, 2022

(51) Int. Cl. G06Q 10/06; G06N 20/00

(52) U.S. Cl. CPC G06Q 10/06313; G06Q 10/06312; G06N 20/00; G06Q 10/0635; G06Q 10/06395

(57) ABSTRACT

In an approach for optimizing project and team success, prior to a user initiating a project, a processor creates a digital profile. A processor sets up the digital profile with a set of data gathered from one or more project related documents for a set of previous projects of the user. Responsive to the user initiating the project, a processor identifies one or more documents related to the project. A processor analyzes the one or more documents related to the project. A processor predicts an outcome of the project using machine learning, wherein the outcome of the project is a set of measures indicating a success factor, a quality factor, and a risk factor of the project. A processor generates an optimization suggestion, wherein the optimization suggestion is a suggestion to adjust one or more parameters of the project. A processor outputs the optimization suggestion to the user.

### BACKGROUND OF THE INVENTION

The present invention relates generally to the field of data processing, and more particularly to an intelligent project optimization experience.

A project is any undertaking, carried out individually or collaboratively, to achieve a particular goal. A project is typically managed by a project manager. A project manager's responsibility is to lead the work of a team to achieve the goal within the given constraints. The goal is described in project documentation, created at the beginning of the project planning process. In addition to creating the goal, the project planning process also involves defining the scope of the project (i.e., the limits of the project); defining major deliverables (i.e., the products or services the team will be producing or delivering); creating a work breakdown structure, as well as schedule and cost baselines; assigning roles and responsibilities to team members; and completing a risk assessment (i.e., identifying risks, the probability of the risks occurring, and the impact the risks will cause should they materialize). Project planning and project management can be done manually or with the use of software.

### SUMMARY

Aspects of an embodiment of the present invention disclose a method, computer program product, and computer system for optimizing project and team success. Prior to a user initiating a project with a project management software, a processor creates a digital profile for the project management software. A processor sets up the digital profile with a set of data gathered from one or more project related documents for a set of previous projects of the user. Responsive to the user initiating the project, a processor identifies one or more documents related to the project. A processor analyzes the one or more documents related to the project. A processor predicts an outcome of the project using machine learning, wherein the outcome of the project is a set of measures indicating a success factor, a quality factor, and a risk factor of the project. A processor generates an optimization suggestion for the project, wherein the optimization suggestion is a suggestion to adjust one or more parameters of the project to mimic one or more attributes of the project. A processor outputs the optimization suggestion for the project to the user.

In some aspects of an embodiment of the present invention, the digital profile provides the user with an aggregated view of one or more previous projects, one or more on-going projects, and one or more upcoming projects in a project portfolio of the user, wherein each project in the project portfolio is to be continuously monitored, analyzed, and compared.

In some aspects of an embodiment of the present invention, subsequent to creating the digital profile for the project management software, a processor defines a common schema, wherein the common schema describes the one or more attributes of each project in the project portfolio of the user, and wherein the one or more attributes of each project in the project portfolio of the user are one or more factors that lead to a successful outcome of each project and one or more factors that lead to an unsuccessful outcome of each project.

In some aspects of an embodiment of the present invention, the one or more attributes of each project in the project portfolio of the user include a set of information about the user, a budget for each project of the user, a timeline for each project of the user, a size of a team working on each project, one or more members of the team working on each project, a level of experience of the one or more members of the team working on each project, a location of each member of the one or more members of the team working on each project, a relationship between at least two members of the one or more members of the team working on each project, and a targeted revenue from each project.

In some aspects of an embodiment of the present invention, the one or more attributes of each project in the project portfolio of the user include one or more factors that indicate a degree of success of each project, and wherein the degree of success of each project is indicated through a direct assessment or an indirect assessment.

In some aspects of an embodiment of the present invention, a processor receives one or more project related documents for a set of previous projects of the user. A processor analyzes the one or more project related documents for the set of previous projects of the user according to the common schema to identify the one or more attributes of each project using a machine learning model. A processor updates a knowledge base with the one or more attributes identified.

In some aspects of an embodiment of the present invention, a processor parses the one or more project related documents for the set of previous projects using a rule-based approach with a set of pre-defined rules. A processor extracts one or more attributes of the project from the one or more project related documents for the set of previous projects. A processor determines whether an attribute was not extracted from the project related documents from the one or more previous projects of the user. Responsive to determining the attribute was not extracted from the project related documents from the one or more previous projects of the user, a processor highlights the attribute not extracted from the project related documents from the one or more previous projects of the user. A processor enables the user to add the attribute not extracted from the one or more documents related to the project.

In some aspects of an embodiment of the present invention, a processor outputs a predicted outcome of the project to the user. A processor enables the user to review the predicted outcome of the project. A processor enables the user to simulate a plurality of what-if scenarios by modifying one or more project parameters through an interaction with the digital profile to find a project configuration that optimizes a level of success of the project and that lowers a level of risk of the project. Responsive to the user modifying the one or more project parameters, a processor updates the predicted outcome of the project, including the set of measures indicating the success factor, the quality factor, and the risk factor of the project.

In some aspects of an embodiment of the present invention, subsequent to outputting the optimization suggestion for the project to the user, a processor determines whether the project is complete. Responsive to determining the project is not complete, a processor monitors the project for one or more updates. Responsive to receiving an update, a processor reevaluates the project. A processor receives an updated assessment of the project. Responsive to receiving an updated assessment of the project that does not exceed a threshold of success, a processor sends an alert notification to the user, notifying the user of the updated assessment of the project. A processor enables the user to simulate a plurality of what-if scenarios by modifying one or more project parameters through an interaction with the digital profile to find a project configuration that optimizes the success of the project and that lowers the risk of the project.

In some aspects of an embodiment of the present invention, subsequent to outputting the optimization suggestion for the project to the user, a processor determines whether the project is complete. Responsive to determining the project is complete, a processor conducts a post-mortem analysis of the project to capture one or more final metrics of the project.

These and other features and advantages of the present invention will be described in, or will become apparent to those of ordinary skill in the art in view of, the following detailed description of the example embodiments of the present invention.

### BRIEF DESCRIPTION OF THE DRAWINGS

FIG. 1 is a block diagram illustrating a distributed data processing environment, in accordance with an embodiment of the present invention;

FIG. 2 is a flowchart illustrating the operational steps for a setup component of an issue detection and resolution program, on a server within the distributed data processing environment of FIG. 1, in accordance with an embodiment of the present invention;

FIG. 3 is a flowchart illustrating the operational steps of the issue detection and resolution program, on the server within the distributed data processing environment of FIG. 1, in accordance with an embodiment of the present invention; and

FIG. 4 is a block diagram illustrating the components of the server within the distributed data processing environment of FIG. 1, in accordance with an embodiment of the present invention.

### DETAILED DESCRIPTION

Embodiments of the present invention recognize that a project is any undertaking, carried out individually or collaboratively, to achieve a particular goal managed by a project manager with the aid of a project management software. Embodiments of the present invention recognize that not all projects are set up for success at the beginning of the project planning process. When an issue arises during a project that is not set up for success, it can be difficult for the project manager and/or the team to identify the underlying causes of the issue. Because the underlying causes of the issues cannot be identified, solutions proposed to resolve the issues may not be successful. For example, the tendency to staff a project with a lower band level of individuals for cost saving results can put the project at risk if the individuals do not have the experience or skill set necessary to meet the demands of the project. Therefore, embodiments of the present invention recognize the need for a system and method to predict team success based on a set of baseline metrics and machine learning techniques.

Embodiments of the present invention provide a system and method to create a digital profile that will optimize project and team success. The digital profile can be used for all phases of a project from initiation to talent acquisition (e.g., recruitment, resourcing, and staffing), to execution, to post-mortem analysis. On the project level, the digital profile can help identify gaps and risks before they happen and can help accelerate projects from the Statements of Work (SOW) (i.e., the outline of deliverables and project goals) and the contract phase of the project to the planning, design, and development phase of the project, leading to more successful outcomes. On the team level, the digital profile can help the team understand where there is the greatest need for talent and specifically target skills and experience levels during the talent acquisition phase of the project. Lastly, the digital profile ensures that risks are assessed and mitigated prior to the start of the project and throughout the project.

Embodiments of the present invention recognize that project management and resourcing tools are currently available. Further, embodiments of the present invention recognize that the project management and resourcing tools currently available assist with various tasks, such as tracking workflows across teams and budgeting resources. However, embodiments of the present invention recognize that the project management and resourcing tools currently available are primarily focused on whether a project will be delivered on time or not.

Embodiments of the present invention, on the other hand, take a holistic, Artificially Intelligent (AI) enabled view of a project and a team, making forecasting and planning of a project smarter—something that none of the project management and resourcing tools currently available can provide. More specifically, embodiments of the present invention evaluate a plurality of attributes of a project (e.g., budget, team structure, staffing, pricing, quality, solution, time-to-delivery, team sentiment, and client satisfaction). Embodiments of the present invention compare and analyze the plurality of attributes against a database of previous successful and unsuccessful project executions. Leveraging input from the database of previous successful and unsuccessful project executions, embodiments of the present invention predict an outcome of the project. Embodiments of the present invention generate suggestions on how to optimize the future outcome of the project (i.e., to improve the likelihood of a more positive project outcome) based on the data stored in the database. The suggestions consider the best mix of resources, deliverable creations, project timelines while also accounting for utilization requirements, gross profits, and other variables used to measure success. Embodiments of the present invention provide the user with the suggestions and allow the user to execute what-if scenarios to help the user understand what aspects of the project are working and what aspects of the project need improvement. Embodiments of the present invention also provide the user with an aggregated view of all previous, on-going, and upcoming projects so that the user can continuously and simultaneously monitor multiple projects across a project portfolio of the user and plan for future success. Embodiments of the present invention continuously monitor the project throughout the execution of the project and collect feedback from the team and the clients. Embodiments of the present invention add the data and feedback collected to the database to produce an even greater knowledge base of best practices that can be used in the future for strategic planning.

Implementation of embodiments of the present invention may take a variety of forms, and exemplary implementation details are discussed subsequently with reference to the Figures.

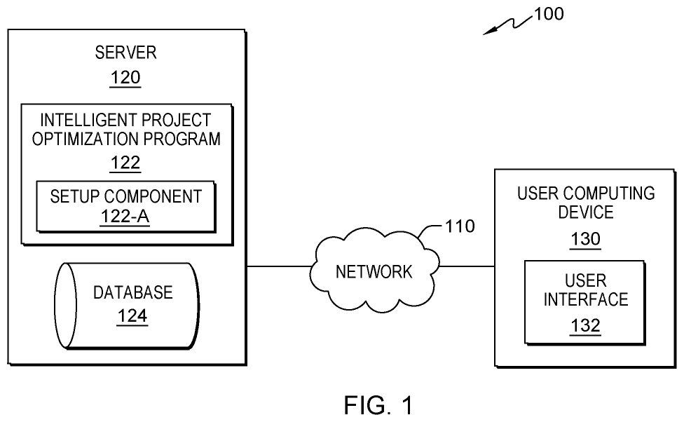

FIG. 1 is a block diagram illustrating a distributed data processing environment, generally designated 100, in accordance with an embodiment of the present invention. In the depicted embodiment, distributed data processing environment 100 includes server 120 and user computing device 130, interconnected over network 110. Distributed data processing environment 100 may include additional servers, computers, computing devices, IoT sensors, and other devices not shown. The term “distributed” as used herein describes a computer system that includes multiple, physically distinct devices that operate together as a single computer system. FIG. 1 provides only an illustration of one embodiment of the present invention and does not imply any limitations with regards to the environments in which different embodiments may be implemented. Many modifications to the depicted environment may be made by those skilled in the art without departing from the scope of the invention as recited by the claims.

Network 110 operates as a computing network that can be, for example, a telecommunications network, a local area network (LAN), a wide area network (WAN), such as the Internet, or a combination of the three, and can include wired, wireless, or fiber optic connections. Network 110 can include one or more wired and/or wireless networks capable of receiving and transmitting data, voice, and/or video signals, including multimedia signals that include data, voice, and video information. In general, network 110 can be any combination of connections and protocols that will support communications between server 120, user computing device 130, and other computing devices (not shown) within distributed data processing environment 100.

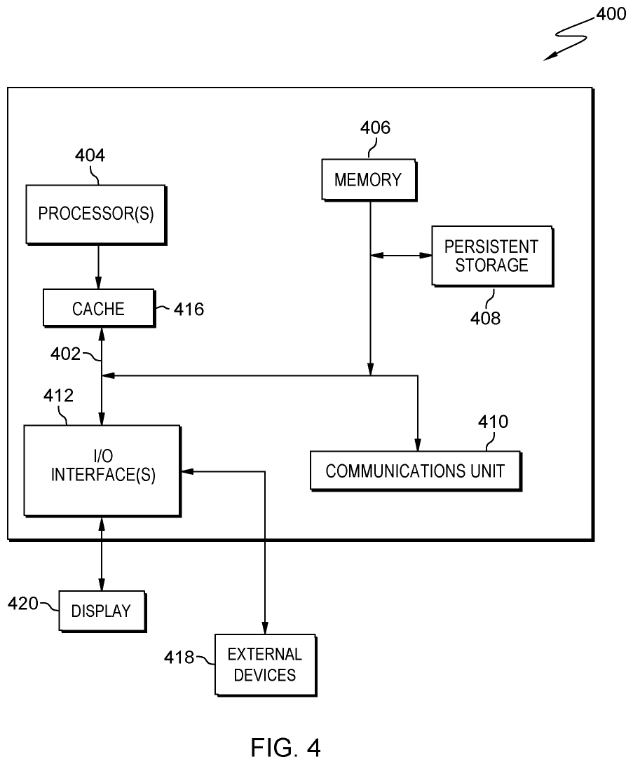

Server 120 operates to run issue detection and resolution program 122 and to send and/or store data in database 124. In an embodiment, server 120 can send data from database 124 to user computing device 130. In an embodiment, server 120 can receive data in database 124 from user computing device 130. In one or more embodiments, server 120 can be a standalone computing device, a management server, a web server, a mobile computing device, or any other electronic device or computing system capable of receiving, sending, and processing data and capable of communicating with user computing device 130 via network 110. In one or more embodiments, server 120 can be a computing system utilizing clustered computers and components (e.g., database server computers, application server computers, etc.) that act as a single pool of seamless resources when accessed within distributed data processing environment 100, such as in a cloud computing environment. In one or more embodiments, server 120 can be a laptop computer, a tablet computer, a netbook computer, a personal computer, a desktop computer, a personal digital assistant, a smart phone, or any programmable electronic device capable of communicating with user computing device 130 and other computing devices (not shown) within distributed data processing environment 100 via network 110. Server 120 may include internal and external hardware components, as depicted and described in further detail in FIG. 4.

Issue detection and resolution program 122 operates to create a digital profile that will optimize project and team success. In an embodiment, issue detection and resolution program 122 uses the digital profile to evaluate a plurality of attributes of a project; compare and analyze the plurality of attributes against a database of previous successful and unsuccessful project executions; predict an outcome of the project; and generate suggestions on how to optimize the future outcome of the project. In the depicted embodiment, issue detection and resolution program 122 is a standalone program. In another embodiment, issue detection and resolution program 122 may be integrated into another software product, such as a project management software. In the depicted embodiment, issue detection and resolution program 122 resides on server 120. In another embodiment, issue detection and resolution program 122 may reside on user computing device 130 or on another computing device (not shown), provided that issue detection and resolution program 122 has access to network 110.

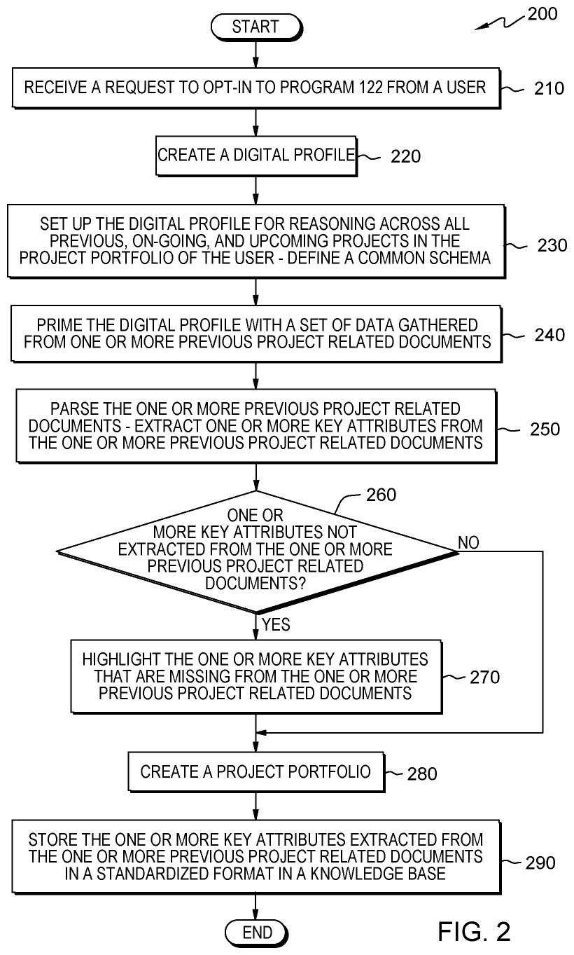

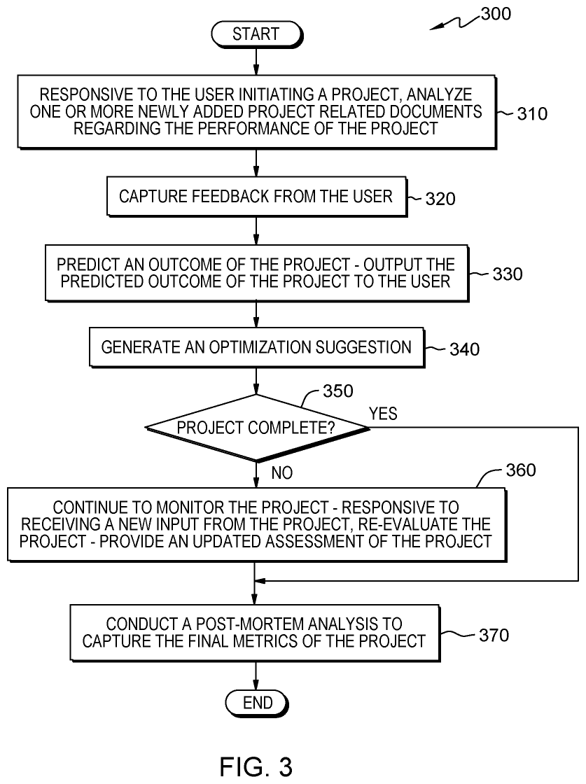

In an embodiment, the user of user computing device 130 registers with issue detection and resolution program 122 of server 120. For example, the user completes a registration process (e.g., user validation), provides information to create a user profile, and authorizes the collection, analysis, and distribution (i.e., opts-in) of relevant data on identified computing devices (e.g., on user computing device 130) by server 120 (e.g., via issue detection and resolution program 122). Relevant data includes, but is not limited to, personal information or data provided by the user or inadvertently provided by the user's device without the user's knowledge; tagged and/or recorded location information of the user (e.g., to infer context (i.e., time, place, and usage) of a location or existence); time stamped temporal information (e.g., to infer contextual reference points); and specifications pertaining to the software or hardware of the user's device. In an embodiment, the user opts-in or opts-out of certain categories of data collection. For example, the user can opt-in to provide all requested information, a subset of requested information, or no information. In one example scenario, the user opts-in to provide time-based information, but opts-out of providing location-based information (on all or a subset of computing devices associated with the user). In an embodiment, the user opts-in or opts-out of certain categories of data analysis. In an embodiment, the user opts-in or opts-out of certain categories of data distribution. Such preferences can be stored in database 124. The operational steps for setup component 122-A of issue detection and resolution program 122 are depicted and described in further detail with respect to FIG. 2. The operational steps of issue detection and resolution program 122 are depicted and described in further detail with respect to FIG. 3.

Database 124 operates as a repository for data received, used, and/or generated by issue detection and resolution program 122. A database is an organized collection of data. Data includes, but is not limited to, information about user preferences (e.g., general user system settings such as alert notifications for user computing device 130); information about alert notification preferences; a project portfolio of the user, including project related documents for one or more previous projects, one or more on-going projects, and one or more upcoming projects of the user; one or more key attributes extracted from the one or more previous project related documents, the one or more on-going project related documents, the one or more upcoming project related documents, and the feedback received; the predicted outcome of the project; the optimization suggestion; the final metrics of the project; the outcomes of what-if scenarios simulated; the feedback received from the team; the feedback received from the clients; and any other data received, used, and/or generated by issue detection and resolution program 122.

Database 124 can be implemented with any type of device capable of storing data and configuration files that can be accessed and utilized by server 120, such as a hard disk drive, a database server, or a flash memory. In an embodiment, database 124 is accessed by issue detection and resolution program 122 to store and/or to access the data. In the depicted embodiment, database 124 resides on server 120. In another embodiment, database 124 may reside on another computing device, server, cloud server, or spread across multiple devices elsewhere (not shown) within distributed data processing environment 100, provided that issue detection and resolution program 122 has access to database 124.

The present invention may contain various accessible data sources, such as database 124, that may include personal and/or confidential company data, content, or information the user wishes not to be processed. Processing refers to any operation, automated or unautomated, or set of operations such as collecting, recording, organizing, structuring, storing, adapting, altering, retrieving, consulting, using, disclosing by transmission, dissemination, or otherwise making available, combining, restricting, erasing, or destroying personal and/or confidential company data. Issue detection and resolution program 122 enables the authorized and secure processing of personal data.

Issue detection and resolution program 122 provides informed consent, with notice of the collection of personal and/or confidential data, allowing the user to opt-in or opt-out of processing personal and/or confidential data. Consent can take several forms. Opt-in consent can impose on the user to take an affirmative action before personal and/or confidential data is processed. Alternatively, opt-out consent can impose on the user to take an affirmative action to prevent the processing of personal and/or confidential data before personal and/or confidential data is processed. Issue detection and resolution program 122 provides information regarding personal and/or confidential data and the nature (e.g., type, scope, purpose, duration, etc.) of the processing. Issue detection and resolution program 122 provides the user with copies of stored personal and/or confidential company data. Issue detection and resolution program 122 allows the correction or completion of incorrect or incomplete personal and/or confidential data. Issue detection and resolution program 122 allows for the immediate deletion of personal and/or confidential data.

User computing device 130 operates to run user interface 132 through which a user can interact with issue detection and resolution program 122 on server 120. In an embodiment, user computing device 130 is a device that performs programmable instructions. For example, user computing device 130 may be an electronic device, such as a laptop computer, a tablet computer, a netbook computer, a personal computer, a desktop computer, a smart phone, or any programmable electronic device capable of running user interface 132 and of communicating (i.e., sending and receiving data) with issue detection and resolution program 122 via network 110. In general, user computing device 130 represents any programmable electronic device or a combination of programmable electronic devices capable of executing machine readable program instructions and communicating with other computing devices (not shown) within distributed data processing environment 100 via network 110. In the depicted embodiment, user computing device 130 includes an instance of user interface 132.

User interface 132 operates as a local user interface between issue detection and resolution program 122 on server 120 and a user of user computing device 130. In some embodiments, user interface 132 is a graphical user interface (GUI), a web user interface (WUI), and/or a voice user interface (VUI) that can display (i.e., visually) or present (i.e., audibly) text, documents, web browser windows, user options, application interfaces, and instructions for operations sent from issue detection and resolution program 122 to a user via network 110. User interface 132 can also display or present alerts including information (such as graphics, text, and/or sound) sent from issue detection and resolution program 122 to a user via network 110. In an embodiment, user interface 132 is capable of sending and receiving data (i.e., to and from issue detection and resolution program 122 via network 110, respectively). Through user interface 132, a user can opt-in to issue detection and resolution program 122; create a user profile; set user preferences and alert notification preferences; input project related documents from one or more previous projects of the user; input project related documents from one or more ongoing projects of the user; add the one or more key attributes that are missing; receive alert notifications; receive the predicted outcome of the project; review the predicted outcome of the project; interact with the digital profile to find the optimal project configuration; modify one or more project parameters; simulate various what-if scenarios to find a configuration that optimizes the success of the project and/or lowers the risk of the project; receive a request for feedback; and input feedback.

A user preference is a setting that can be customized for a particular user. A set of default user preferences are assigned to each user of issue detection and resolution program 122. A user preference editor can be used to update values to change the default user preferences. User preferences that can be customized include, but are not limited to, general user system settings, specific user profile settings, alert notification settings, and machine-learned data collection/storage settings. Machine-learned data is a user's personalized corpus of data. Machine-learned data includes, but is not limited to, past results of iterations of issue detection and resolution program 122.

FIG. 2 is a flowchart, generally designated 200, illustrating the operational steps for setup component 122-A of issue detection and resolution program 122, on server 120 within distributed data processing environment 100 of FIG. 1, in accordance with an embodiment of the present invention. In an embodiment, issue detection and resolution program 122 operates to complete a one-time setup with the user. The one-time setup allows for issue detection and resolution program 122 to capture relevant information about the user to create a digital profile. It should be appreciated that the process depicted in FIG. 2 illustrates one possible iteration of the process flow, which may be repeated for each opt-in request received by issue detection and resolution program 122.

In step 210, setup component 122-A of issue detection and resolution program 122 (hereinafter referred to as “program 122”) receives a request to opt-in to program 122 from a user. In an embodiment, setup component 122-A of program 122 receives a request to opt-in to program 122 from a user through user interface 132 of user computing device 130. By opting-in, the user agrees to share data with database 124. In an embodiment, setup component 122-A of program 122 validates the request to opt-in.

In step 220, setup component 122-A of program 122 creates a digital profile for the user. The digital profile provides the user with an aggregated view of all previous, on-going, and upcoming projects in a project portfolio of the user. With an aggregated view, the user can continuously monitor, analyze, and compare multiple attributes of all the projects in the project portfolio of the user. The user can interact with the digital profile via user interface 132 of user computing device 130.

In step 230, setup component 122-A of program 122 sets-up the digital profile. In an embodiment, setup component 122-A of program 122 sets-up the digital profile by preparing the digital profile for analyzing all previous, on-going, and upcoming projects in the project portfolio of the user. In an embodiment, setup component 122-A of program 122 sets-up the digital profile by defining a common schema automatically (i.e., by using a set of pre-populated key attributes of a project). In an embodiment, setup component 122-A of program 122 sets-up the digital profile by defining a common schema manually (i.e., by enabling the user to populate a set of pre-populated key attributes of a project). The common schema describes one or more key attributes that are captured for each project in the project portfolio of the user. The one or more key attributes are one or more factors that significantly impact the outcome of each project (i.e., lead to a successful outcome of each project or lead to an unsuccessful outcome of each project). The one or more key attributes may include, but are not limited to, a set of information about the user (e.g., name of the user, industry, size, etc.), a budget for each project of the user, a timeline for each project of the user, a size of a team working on each project, one or more members of the team working on each project, a level of experience of the one or more members of the team working on each project, a location of each member of the one or more members of the team working on each project, a relationship between at least two members of the one or more members of the team working on each project, and a targeted revenue from each project. The one or more key attributes are also one or more factors that indicate a degree of success of each project. The degree of success of each project is indicated either via a direct assessment (e.g., not successful or very successful) or indirect assessments (e.g., delay in delivery, budget overrun, customer satisfaction). The one or more key attributes may differ between types of projects. The base schema is defined before any data is collected, but evolves over time as new, critical key attributes are discovered. When new, critical key attributes are discovered, historical information is either populated post-mortem or values are treated as missing.

In step 240, setup component 122-A of program 122 primes the digital profile with a set of data gathered from one or more project related documents for a set of previous projects of the user (hereinafter referred to as the “one or more previous project related documents”). In an embodiment, setup component 122-A of program 122 gathers the one or more previous project related documents from a knowledge base (e.g., database 124) of a server (e.g., server 120). In another embodiment, setup component 122-A of program 122 enables the user to input the one or more previous project related documents through user interface 132 of user computing device 130. The one or more previous project related documents may include, but are not limited to, a document in a structured format (e.g., a customer list, a budget, etc.), a document in a semi-structured format, and/or a document in an unstructured format (e.g., a Request for Proposal (RFP), a SOW, etc.) that was used by the customer to describe the requested work (e.g., via the RFP) or was authored by the provider outlining how the work would be performed (e.g., a project proposal). The one or more previous project related documents may also include, but are not limited to, qualitative data and/or quantitative data. Program 122 utilizes both qualitative data and quantitative data to ensure the highest level of quality assurance. In an embodiment, program 122 transforms qualitative data into quantitative data through an application of fuzzy logic. Fuzzy logic is a form of many-valued logic in which the truth value of variables may be any real number between 0 and 1. Fuzzy logic is employed to handle the concept of partial truth, where the truth value may range from completely true to completely false. Fuzzy logic is based on the observation that people make decisions based on imprecise and non-numerical information. Fuzzy sets are mathematical means of representing vagueness and imprecise information. Fuzzy sets have the capability of recognizing, representing, manipulating, interpreting, and using data and information that is vague and lacks certainty. Fuzzification is the process of assigning the numerical input of a system to fuzzy sets with some degree of membership. This degree of membership may be anywhere within the interval [0,1]. If it is 0, then the value does not belong to the given fuzzy set, and if it is 1, then the value completely belongs within the fuzzy set. Any value between 0 and 1 represents the degree of uncertainty that the value belongs in the set. These fuzzy sets are typically described by words, and so by assigning the system input to fuzzy sets, the fuzzy sets can be reasoned with it in a linguistically natural manner. Fuzzy sets are often defined as triangle or trapezoid-shaped curves, as each value will have a slope where the value is increasing, a peak where the value is equal to 1 (which can have a length of 0 or greater) and a slope where the value is decreasing. They can also be defined using a sigmoid function.

In step 250, setup component 122-A of program 122 parses the one or more previous project related documents. In an embodiment, setup component 122-A of program 122 parses the one or more previous project related documents using a rule-based approach with a set of pre-defined rules. In another embodiment, setup component 122-A of program 122 parses the one or more previous project related documents by leveraging a set of machine learning and machine learned patterns. In an embodiment, setup component 122-A of program 122 extracts the one or more key attributes from the one or more previous project related documents. Using the rule-based approach, the set of rules may be pre-defined to express, for example, the budget for a proposal as a number that appears in the context of a term, such as “total cost” or “final amount”. The set of rules heavily depend on the common formatting used within an organization of the user. In the machine learning based approach, the set of rules may not be specified explicitly. However, a machine learning algorithm may be trained by annotating the one or more key attributes in historical documents and by using the annotated historical documents to teach the algorithm how to recognize the one or more key attributes in future documents.

In decision step 260, setup component 122-A of program 122 determines whether any of the one or more key attributes were not extracted from the one or more previous project related documents. In an embodiment, setup component 122-A of program 122 determines whether any of the one or more key attributes were not extracted from the one or more previous project related documents because the one or more key attributes were not present in the one or more previous project related documents. In another embodiment, setup component 122-A of program 122 determines whether any of the one or more key attributes were not extracted from the one or more previous project related documents because the parser was not able to recognize the one or more key attributes in the one or more previous project related documents.

If setup component 122-A of program 122 determines that one or more key attributes were not extracted from the one or more previous project related documents (decision step 260, YES branch), then setup component 122-A of program 122 proceeds to step 270, highlighting the one or more key attributes that are missing. If setup component 122-A of program 122 determines that each key attribute of the one or more key attributes was extracted from the one or more previous project related documents (decision step 260, NO branch), then setup component 122-A of program 122 proceeds to step 280, creating a project portfolio.

Decision step 260 (i.e., ensuring that each of the one or more key attributes are extracted from the one or more previous project related documents) is crucial for the analyzation of the project. This step enables the subsequent learning and analyzing steps. This step was designed to leverage already existing artifacts. By doing so, the burden on the user is lowered because the user is required to provide fewer key attributes of the project.

In step 270, setup component 122-A of program 122 highlights the one or more key attributes that are missing from the one or more previous project related documents. In an embodiment, setup component 122-A of program 122 sends an alert notification to the user via user interface 132 of user computing device 130. In an embodiment, setup component 122-A of program 122 sends an alert notification to the user, notifying the user of the one or more key attributes that are missing from the one or more previous project related documents. In an embodiment, setup component 122-A of program 122 enables the user to add the one or more key attributes that are missing from the one or more previous project related documents. In an embodiment, setup component 122-A of program 122 enables the user to add the one or more key attributes that are missing from the one or more previous project related documents so that the user can create a project portfolio that is as complete as possible. In an embodiment, setup component 122-A of program 122 enables the user to add the one or more key attributes that are missing from the one or more previous project related documents through user interface 132 of user computing device 130.

In step 280, setup component 122-A of program 122 creates a project portfolio. In an embodiment, setup component 122-A of program 122 stores the project portfolio in a knowledge base (e.g., database 124) of a server (e.g., server 120). In an embodiment, setup component 122-A of program 122 stores the project portfolio to be used later to optimize one or more parameters of a new project and one or more resources of the new project. In an embodiment, setup component 122-A of program 122 stores the project portfolio to be used later to calculate an outcome of the new project. In an embodiment, setup component 122-A of program 122 provides recommendations on how to categorize, prioritize, and identify dependencies between projects in the project portfolio.

In step 290, setup component 122-A of program 122 stores the one or more key attributes extracted from the one or more previous project related documents in a standardized format in the knowledge base (e.g., database 124) of the server (e.g., server 120). The one or more key attributes extracted from the one or more previous project related documents form a baseline of the knowledge base. The baseline may also be referred to as a ground truth data set. The formation of the ground truth data set is the most labor-intensive part of creating the digital profile. To lessen the initial burden and reduce the time to deploy the digital profile, the process is started with a smaller set of ground truth data. That will lead to a less precise algorithm. However, bootstrapping can be applied to incrementally gather more ground truth data and lead to more and more accurate predictions. More specifically, by starting off with a limited amount of ground truth data, a user will start using the digital profile, but only as a secondary reference point (i.e., knowing that the digital profile is less accurate). Then, as the user enters information about the one or more key attributes of a project and, later, an outcome of the project, the digital profile grows its knowledge base. The machine learning algorithm will also grow more precise over time.

The one or more key attributes extracted from the one or more previous project related documents are used to train the machine learning algorithm used by the digital profile to predict an outcome of a project. In an embodiment, the machine learning algorithm is a multiple linear regression model. In another embodiment, the machine learning algorithm is a neural network model. The neural network model finds “hidden” patterns and correlations between a project input (e.g., one or more key attributes extracted from one or more project related documents) and a project outcome (i.e., the success factor, the quality factor, and the risk factor of the project). The neural network model is trained on a ground truth data set that correlates observations or inputs (e.g., one or more key attributes extracted from one or more project related documents) to outcomes (e.g., the success factor, the quality factor, and the risk factor of the project).

FIG. 3 is a flowchart, generally designated 300, illustrating the operational steps of program 122, on server 120 within distributed data processing environment 100 of FIG. 1, in accordance with an embodiment of the present invention. In an embodiment, program 122 operates to use the digital profile to evaluate a plurality of attributes of a project, compare and analyze the plurality of attributes against a database of previous successful and unsuccessful project executions; predict an outcome of the project, and generate suggestions on how to optimize the future outcome of the project. It should be appreciated that the process depicted in FIG. 3 illustrates one possible iteration of the process flow, which may be repeated continually for the length of the project initiated by the user.

In step 310, responsive to the user initiating a project, program 122 analyzes one or more newly added project related documents regarding the performance of the project (e.g., structured and unstructured documents). In an embodiment, program 122 receives one or more newly added project related documents input by the user through user interface 132 of user computing device 130. In an embodiment, program 122 analyzes the one or more newly added project related documents. In an embodiment, program 122 analyzes by parsing the one or more newly added project related documents using a rule-based approach with a set of pre-defined rules. In another embodiment, program 122 parses the one or more newly added project related documents using a machine learning based approach. In an embodiment, after parsing the one or more newly added project related documents, program 122 extracts one or more key attributes of the project from the one or more newly added project related documents.

In an embodiment, program 122 determines whether any of the one or more key attributes were not extracted from the one or more newly added project related documents. In an embodiment, program 122 determines whether any of the one or more key attributes were not extracted from the one or more newly added project related documents because the one or more key attributes were not present in the one or more newly added project related documents. In another embodiment, program 122 determines whether any of the one or more key attributes were not extracted from the one or more newly added project related documents because the parser was not able to recognize the one or more key attributes in the one or more newly added project related documents.

In an embodiment, responsive to determining one or more key attributes were not extracted from the one or more newly added project related documents, program 122 highlights the one or more key attributes that are missing. In an embodiment, program 122 sends an alert notification to the user via user interface 132 of user computing device 130. In an embodiment, program 122 sends an alert notification, notifying the user of the one or more key attributes that are missing. In an embodiment, program 122 enables the user to add the one or more key attributes that are missing so that the user can create a project portfolio that is as complete as possible. In an embodiment, program 122 enables the user to add the one or more key attributes that are missing through user computing device 132 of user computing device 130. In another embodiment, program 122 adds the one or more key attributes that are missing using the machine learning algorithm. The machine learning algorithm may determine the likely values for missing data. The machine learning algorithm may provide recommendations for entering accurately the missing data. The machine learning algorithm may therefore solve issues in data input and provide the system itself with new complete data sets to learn from pertaining to the project. The evolving predictions made are only as good as the data the model is supplied with, thus enhanced data results in enhanced decision-making.

In an embodiment, program 122 updates the knowledge base. In an embodiment, program 122 updates the knowledge base with the one or more key attributes of the project extracted from the one or more newly added project related documents. In an embodiment, program 122 stores the one or more key attributes of the project in the knowledge base (e.g., database 124) of the server (e.g., server 120). The one or more key attributes of the project extracted from the one or more newly added project related documents serve as additional training data for the machine learning algorithm.

In step 320, program 122 captures feedback (e.g., structured and unstructured feedback) from the user. In an embodiment, program 122 captures feedback input through user interface 132 of user computing device 130. In an embodiment, program 122 captures feedback (e.g., structured and unstructured feedback) from the one or more team members of the project. In an embodiment, program 122 captures feedback (e.g., structured and unstructured feedback) from the client of the user.

In an embodiment, program 122 parses the feedback using a rule-based approach with a set of pre-defined rules. In another embodiment, program 122 parses the feedback using a machine learning based approach. In an embodiment, program 122 extracts the one or more key attributes of the project from the feedback. In an embodiment, program 122 updates the knowledge base with the one or more key attributes of the project extracted from the feedback. In an embodiment, program 122 stores the one or more key attributes of the project in the knowledge base (e.g., database 124) of the server (e.g., server 120). The one or more key attributes of the project extracted from the feedback serve as additional training data for the machine learning algorithm.

In step 330, program 122 predicts an outcome of the project. In an embodiment, project 122 predicts an outcome of the project using the digital profile. The digital profile predicts the outcome of the project using the machine learning algorithm. In another embodiment, project 122 predicts an outcome of each sample (e.g., project) in the ground truth data set. The predicted outcome is a set of measures indicating a success factor, a quality factor, and a risk factor of the project.

In an embodiment, program 122 outputs the predicted outcome of the project to the user through user interface 132 of user computing device 130. In an embodiment, program 122 enables the user to review the predicted outcome of the project through user interface 132 of user computing device 130. In an embodiment, program 122 enables the user to interact with the digital profile to find the optimal project configuration through user interface 132 of user computing device 130. In an embodiment, program 122 enables the user to modify one or more project parameters through user interface 132 of user computing device 130. In an embodiment, responsive to the user modifying one or more project parameters, program 122 updates the success factor, the quality factor, and the risk factor. In an embodiment, program 122 enables the user to simulate a plurality of what-if scenarios to find a project configuration that optimizes a level of success of the project and/or that lowers a level of risk of the project through user interface 132 of user computing device 130. In an embodiment, program 122 enables the user to leverage the information in the knowledge base to make smarter decisions when defining project parameters and when making resource decisions.

In step 340, program 122 generates an optimization suggestion. In an embodiment, program 122 enables a user to generate an optimization suggestion manually with information contained in the knowledge base. The information contained in the knowledge base may include, but is not limited to, information about the relationship between inputs to the project and its performance. The information contained in the knowledge base guides the user in optimizing the project by enabling the user to generate suggestions for how to modify input parameters (e.g., budget, schedule, or resources). In another embodiment, program 122 generates an optimization suggestion using the digital profile. The digital profile generates the optimization suggestion using the machine learning algorithm that was trained on the project portfolio of the user, including project related documents for one or more previous projects, one or more on-going projects, one or more upcoming projects of the user, and feedback received from the team and the clients. The machine learning algorithm starts with an initial state as defined by the project inputs entered by the user. The machine learning algorithm then explores different project configurations that deviate slightly from the original. The machine learning algorithm generates an outcome for each of the project configurations. The project configurations that seem promising are pursued further, while the project configurations that do not seem promising are terminated. The outcome is a set of project configurations that lead to a more desirable outcome than the project configuration originally provided by the user (i.e., a suggestion to adjust one or more factors of the project to mimic one or more key attributes that lead to a successful outcome of the project). In an embodiment, program 122 enables the user to interact with the process by guiding the machine learning algorithm in pursuing a specific path and abandoning others. In an embodiment, program 122 outputs the optimization suggestion to the user through user interface 132 of user computing device 130. In an embodiment, program 122 stores the optimization suggestion in the knowledge base (e.g., database 124) of the server (e.g., server 120). In an embodiment, program 122 stores the optimization suggestion in the knowledge base of the server to be used for future optimizations and to guide the exploration of promising project configurations. For example, if a user tends to abandon paths that suggest increasing the budget, then future runs will reduce the likelihood that such a path will be generated by adjusting the respective weights in the model. The optimization process learns with experience and becomes more powerful over time.

In decision 350, program 122 determines whether the project is complete. If program 122 determines the project is complete (decision 350, YES branch), then program 122 proceeds to step 370, conducting a post-mortem analysis. If program 122 determines the project is not complete (decision 350, NO branch), the program 122 proceeds to step 360, continuing to monitor the project and to update the machine learning algorithm as needed.

In step 360, program 122 continues to monitor the project. In an embodiment, responsive to receiving a new input from the project, program 122 re-evaluates the project. In an embodiment, program 122 provides an updated assessment of the project. In an embodiment, responsive to receiving an updated assessment of the project that shows a less favorable outcome than initially planned (i.e., an updated assessment that does not exceed a threshold of success), program 122 sends an alert notification. In an embodiment, program 122 sends an alert notification to the user through user interface 132 of user computing device 130. In an embodiment, program 122 sends an alert notification, notifying the user of the less favorable outcome. In an embodiment, program 122 enables the user to use the digital profile to optimize the project in order to get the project back on track to achieve a successful outcome. Such continuous monitoring provides the user with greater transparency with very little additional effort. Furthermore, with the benefits provided by the continuous monitoring and re-evaluation of the project, the user and the one or more team members of the project are incentivized to provide real-time feedback.

In step 370, program 122 conducts a post-mortem analysis to capture the final metrics of the project. In an embodiment, program 122 stores the final metrics of the project in the knowledge base (e.g., database 124) of the server (e.g., server 120).

In an example, user X, a partner at a company, has been working with a banking firm to bring in new business for the company. User X creates a resourcing and staffing proposal for a client, NewClient. User X has many years of experience, established relationships, and deep knowledge of the sector. However, user X is unfamiliar with how to resource and staff a creative team for optimal success. User X's last project had many issues, from inexperienced team members to little oversight, high turnover, and missed deadlines. User X has to prioritize making user X's financial targets. User X does not have much insight into what happened, although she is keen to avoid another outcome like that on her next signing. NewClient has asked for an estimate for a website redesign. User X inputs the information user X has on NewClient and uploads the RFP (and other materials) into the digital profile. Based on the staffing history of previous successful engagements in this and other sectors, the digital profile proposes roles and band levels as well as a menu of offerings, from design to implementation, and projected timelines. User X can easily compare multiple what-if scenarios, adjust band levels, roles, and timelines. User X decides on a resourcing plan user X thinks will appeal to NewClient and enters it into the system for a manager to review.

In another example, user Y, a delivery lead, has been reviewing proposals created by partners. When a staff plan is issued for a project over a certain clip level, user Y needs to see the staff plan to ensure resources are staffed full time. If they aren't, user Y wants to know why—and how to solve the issue. User Y routinely reviews partner proposals for feasibility and probability of success. User Y's experience allows her to catch details, provide input, and make recommendations. At the same time, user Y is training the system to think more like user Y does. User Y has access to a broader view of projects by sector, practice, division, and even across the enterprise. The system alerts her to patterns of success as well as risk. User Y is then able to drill into the data, analyze it, and input her own insights, which the system uses to learn. User Y is also able to customize user Y's alerts.

FIG. 4 is a block diagram, generally designated 400, illustrating the components of server 120 within distributed data processing environment 100 of FIG. 1, in accordance with an embodiment of the present invention. It should be appreciated that FIG. 4 provides only an illustration of one implementation and does not imply any limitations with regard to the environments in which different embodiments can be implemented. Many modifications to the depicted environment can be made.

Computing device 400 includes processor(s) 404, memory 406, cache 416, communications fabric 402, persistent storage 408, input/output (I/O) interface(s) 412, and communications unit 410.

Communications fabric 402 provides communications between memory 406, cache 416, persistent storage 408, input/output (I/O) interface(s) 412, and communications unit 410. Communications fabric 402 can be implemented with any architecture designed for passing data and/or control information between processors (such as microprocessors, communications and network processors, etc.), system memory, peripheral devices, and any other hardware components within a system. For example, communications fabric 402 can be implemented with one or more buses or a cross switch.

Memory 406 and persistent storage 408 are computer readable storage media. In this embodiment, memory 406 includes random access memory (RAM). In general, memory 406 can include any suitable volatile or non-volatile computer readable storage media. Cache 416 is a fast memory that enhances the performance of computer processor(s) 404 by holding recently accessed data, and data near accessed data, from memory 406.

Program instructions and data (e.g., software and data) used to practice embodiments of the present invention may be stored in persistent storage 408 and in memory 406 for execution by one or more of the respective processor(s) 404 via cache 416. In an embodiment, persistent storage 408 includes a magnetic hard disk drive. Alternatively, or in addition to a magnetic hard disk drive, persistent storage 408 can include a solid-state hard drive, a semiconductor storage device, a read-only memory (ROM), an erasable programmable read-only memory (EPROM), a flash memory, or any other computer readable storage media that is capable of storing program instructions or digital information.

The media used by persistent storage 408 may also be removable. For example, a removable hard drive may be used for persistent storage 408. Other examples include optical and magnetic disks, thumb drives, and smart cards that are inserted into a drive for transfer onto another computer readable storage medium that is also part of persistent storage 408. Software and data can be stored in persistent storage 408 for access and/or execution by one or more of the respective processor(s) 404 via cache 416. With respect to user computing device 130, software and data includes user interface 132. With respect to server 120, software and data includes program 122.

Communications unit 410, in these examples, provides for communications with other data processing systems or devices. In these examples, communications unit 410 includes one or more network interface cards. Communications unit 410 may provide communications through the use of either or both physical and wireless communications links. Program instructions and data (e.g., software and data) used to practice embodiments of the present invention may be downloaded to persistent storage 408 through communications unit 410.

I/O interface(s) 412 allows for input and output of data with other devices that may be connected to each computer system. For example, I/O interface(s) 412 may provide a connection to external device(s) 418, such as a keyboard, a keypad, a touch screen, and/or some other suitable input device. External device(s) 418 can also include portable computer readable storage media, such as, for example, thumb drives, portable optical or magnetic disks, and memory cards. Program instructions and data (e.g., software and data) used to practice embodiments of the present invention can be stored on such portable computer readable storage media and can be loaded onto persistent storage 408 via I/O interface(s) 412. I/O interface(s) 412 also connect to display 420.

Display 420 provides a mechanism to display data to a user and may be, for example, a computer monitor.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

While particular embodiments of the present invention have been shown and described here, it will be understood to those skilled in the art that, based upon the teachings herein, changes and modifications may be made without departing from the embodiments and its broader aspects. Therefore, the appended claims are to encompass within their scope all such changes and modifications as are within the true spirit and scope of the embodiments. Furthermore, it is to be understood that the embodiments are solely defined by the appended claims. It will be understood by those with skill in the art that if a specific number of an introduced claim element is intended, such intent will be explicitly recited in the claim, and in the absence of such recitation no such limitation is present. For a non-limiting example, as an aid to understand, the following appended claims contain usage of the introductory phrases “at least one” and “one or more” to introduce claim elements. However, the use of such phrases should not be construed to imply that the introduction of a claim element by the indefinite articles “a” or “an” limits any particular claim containing such introduced claim element to embodiments containing only one such element, even when the same claim includes the introductory phrases “at least one” or “one or more” and indefinite articles such as “a” or “an”, the same holds true for the use in the claims of definite articles.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart illustrations and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart illustrations and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart illustrations and/or block diagram block or blocks.

The flowchart illustrations and block diagrams in the Figures illustrate the architecture, functionality, and operation of possible implementations of systems, methods, and computer program products according to various embodiments of the present invention. In this regard, each block in the flowchart illustrations or block diagrams may represent a module, segment, or portion of instructions, which comprises one or more executable instructions for implementing the specified logical function(s). In some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each flowchart illustration and/or block of the block diagrams, and combinations of flowchart illustration and/or blocks in the block diagrams, can be implemented by special purpose hardware-based systems that perform the specified functions or acts or carry out combinations of special purpose hardware and computer instructions.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the invention. The terminology used herein was chosen to best explain the principles of the embodiment, the practical application or technical improvement over technologies found in the marketplace, or to enable others of ordinary skill in the art to understand the embodiments disclosed herein.

What is claimed is:

1. A computer-implemented method comprising:
prior to a user initiating a project with a project management software, creating, by one or more processors, a digital profile for the project management software;
setting up, by the one or more processors, the digital profile with a set of data gathered from one or more project related documents for a set of previous projects of the user;
responsive to the user initiating the project, identifying, by one or more processors, one or more documents related to the project;
analyzing, by the one or more processors, the one or more documents related to the project;
predicting, by the one or more processors, an outcome of the project using machine learning, wherein the outcome of the project is a set of measures indicating a success factor, a quality factor, and a risk factor of the project;
generating, by the one or more processors, an optimization suggestion for the project, wherein the optimization suggestion is a suggestion to adjust one or more parameters of the project to mimic one or more attributes of the project; and
outputting, by the one or more processors, the optimization suggestion for the project to the user.

2. The computer-implemented method of claim 1, wherein the digital profile provides the user with an aggregated view of one or more previous projects, one or more on-going projects, and one or more upcoming projects in a project portfolio of the user, wherein each project in the project portfolio is to be continuously monitored, analyzed, and compared.

3. The computer-implemented method of claim 1, further comprising:
subsequent to creating the digital profile for the project management software, defining, by the one or more processors, a common schema, wherein the common schema describes the one or more attributes of each project in the project portfolio of the user, and wherein the one or more attributes of each project in the project portfolio of the user are one or more factors that lead to a successful outcome of each project and one or more factors that lead to an unsuccessful outcome of each project.

4. The computer-implemented method of claim 3, wherein the one or more attributes of each project in the project portfolio of the user include a set of information about the user, a budget for each project of the user, a timeline for each project of the user, a size of a team working on each project, one or more members of the team working on each project, a level of experience of the one or more members of the team working on each project, a location of each member of the one or more members of the team working on each project, a relationship between at least two members of the one or more members of the team working on each project, and a targeted revenue from each project.

5. The computer-implemented method of claim 3, wherein the one or more attributes of each project in the project portfolio of the user include one or more factors that indicate a degree of success of each project, and wherein the degree of success of each project is indicated through a direct assessment or an indirect assessment.

6. The computer-implemented method of claim 1, wherein setting up the digital profile with the set of data gathered from the one or more project related documents for the set of previous projects of the user further comprises:
receiving, by the one or more processors, one or more project related documents for a set of previous projects of the user;
analyzing, by the one or more processors, the one or more project related documents for the set of previous projects of the user according to the common schema to identify the one or more attributes of each project using a machine learning model; and
updating, by the one or more processors, a knowledge base with the one or more attributes identified.

7. The computer-implemented method of claim 6, wherein analyzing the one or more project related documents for the set of previous projects of the user according to the common schema to identify the one or more attributes of each project using the machine learning model further comprises:
parsing, by the one or more processors, the one or more project related documents for the set of previous projects using a rule-based approach with a set of pre-defined rules;
extracting, by the one or more processors, one or more attributes of the project from the one or more project related documents for the set of previous projects;
determining, by the one or more processors, whether an attribute was not extracted from the project related documents from the one or more previous projects of the user;
responsive to determining the attribute was not extracted from the project related documents from the one or more previous projects of the user, highlighting, by the one or more processors, the attribute not extracted from the project related documents from the one or more previous projects of the user; and
enabling, by the one or more processors, the user to add the attribute not extracted from the one or more documents related to the project.

8. The computer-implemented method of claim 1, wherein predicting the outcome of the project using machine learning further comprises:
outputting, by the one or more processors, a predicted outcome of the project to the user;
enabling, by the one or more processors, the user to review the predicted outcome of the project;
enabling, by the one or more processors, the user to simulate a plurality of what-if scenarios by modifying one or more project parameters through an interaction with the digital profile to find a project configuration that optimizes a level of success of the project and that lowers a level of risk of the project; and
responsive to the user modifying the one or more project parameters, updating, by the one or more processors, the predicted outcome of the project, including the set of measures indicating the success factor, the quality factor, and the risk factor of the project.

9. The computer-implemented method of claim 1, further comprising:
subsequent to outputting the optimization suggestion for the project to the user, determining, by the one or more processors, whether the project is complete;
responsive to determining the project is not complete, monitoring, by the one or more processors, the project for one or more updates;
responsive to receiving an update, reevaluating, by the one or more processors, the project;
receiving, by the one or more processors, an updated assessment of the project;
responsive to receiving an updated assessment of the project that does not exceed a threshold of success, sending, by the one or more processors, an alert notification to the user, notifying the user of the updated assessment of the project; and
enabling, by the one or more processors, the user to simulate a plurality of what-if scenarios by modifying one or more project parameters through an interaction with the digital profile to find a project configuration that optimizes the success of the project and that lowers the risk of the project.

10. The computer-implemented method of claim 1, further comprising:
subsequent to outputting the optimization suggestion for the project to the user, determining, by the one or more processors, whether the project is complete;
responsive to determining the project is complete, conducting, by the one or more processors, a post-mortem analysis of the project to capture one or more final metrics of the project.

11. A computer program product comprising:
one or more computer readable storage media and program instructions stored on the one or more computer readable storage media, the program instructions comprising:
prior to a user initiating a project with a project management software, program instructions to create a digital profile for the project management software;
program instructions to set up the digital profile with a set of data gathered from one or more project related documents for a set of previous projects of the user;
responsive to the user initiating the project, program instructions to identify one or more documents related to the project;
program instructions to analyze the one or more documents related to the project;
program instructions to predict an outcome of the project using machine learning, wherein the outcome of the project is a set of measures indicating a success factor, a quality factor, and a risk factor of the project;
program instructions to generate an optimization suggestion for the project, wherein the optimization suggestion is a suggestion to adjust one or more parameters of the project to mimic one or more attributes of the project; and
program instructions to output the optimization suggestion for the project to the user.

12. The computer program product of claim 11, further comprising:
subsequent to creating the digital profile for the project management software, program instructions to define a common schema, wherein the common schema describes the one or more attributes of each project in the project portfolio of the user, and wherein the one or more attributes of each project in the project portfolio of the user are one or more factors that lead to a successful outcome of each project and one or more factors that lead to an unsuccessful outcome of each project.

13. The computer program product of claim 11, wherein setting up the digital profile with the set of data gathered from the one or more project related documents for the set of previous projects of the user further comprises:
program instructions to receive one or more project related documents for a set of previous projects of the user;
program instructions to analyze the one or more project related documents for the set of previous projects of the user according to the common schema to identify the one or more attributes of each project using a machine learning model; and
program instructions to update a knowledge base with the one or more attributes identified.

14. The computer program product of claim 13, wherein analyzing the one or more project related documents for the set of previous projects of the user according to the common schema to identify the one or more attributes of each project using the machine learning model further comprises:
program instructions to parse the one or more project related documents for the set of previous projects using a rule-based approach with a set of pre-defined rules;
program instructions to extract one or more attributes of the project from the one or more project related documents for the set of previous projects;
program instructions to determine whether an attribute was not extracted from the project related documents from the one or more previous projects of the user;
responsive to determining the attribute was not extracted from the project related documents from the one or more previous projects of the user, program instructions to highlight the attribute not extracted from the project related documents from the one or more previous projects of the user; and
program instructions to enable the user to add the attribute not extracted from the one or more documents related to the project.

15. The computer program product of claim 11, wherein predicting the outcome of the project using machine learning further comprises:
program instructions to output a predicted outcome of the project to the user;
program instructions to enable the user to review the predicted outcome of the project;
program instructions to enable the user to simulate a plurality of what-if scenarios by modifying one or more project parameters through an interaction with the digital profile to find a project configuration that optimizes a level of success of the project and that lowers a level of risk of the project; and
responsive to the user modifying the one or more project parameters, program instructions to update the predicted outcome of the project, including the set of measures indicating the success factor, the quality factor, and the risk factor of the project.

16. A computer system comprising:
one or more computer processors;
one or more computer readable storage media;
program instructions collectively stored on the one or more computer readable storage media for execution by at least one of the one or more computer processors, the stored program instructions comprising:
prior to a user initiating a project with a project management software, program instructions to create a digital profile for the project management software;
program instructions to set up the digital profile with a set of data gathered from one or more project related documents for a set of previous projects of the user;
responsive to the user initiating the project, program instructions to identify one or more documents related to the project;
program instructions to analyze the one or more documents related to the project;
program instructions to predict an outcome of the project using machine learning, wherein the outcome of the project is a set of measures indicating a success factor, a quality factor, and a risk factor of the project;
program instructions to generate an optimization suggestion for the project, wherein the optimization suggestion is a suggestion to adjust one or more parameters of the project to mimic one or more attributes of the project; and
program instructions to output the optimization suggestion for the project to the user.

17. The computer system of claim 16, further comprising:
subsequent to creating the digital profile for the project management software, program instructions to define a common schema, wherein the common schema describes the one or more attributes of each project in the project portfolio of the user, and wherein the one or more attributes of each project in the project portfolio of the user are one or more factors that lead to a successful outcome of each project and one or more factors that lead to an unsuccessful outcome of each project.

18. The computer system of claim 16, wherein setting up the digital profile with the set of data gathered from the one or more project related documents for the set of previous projects of the user further comprises:
program instructions to receive one or more project related documents for a set of previous projects of the user;
program instructions to analyze the one or more project related documents for the set of previous projects of the user according to the common schema to identify the one or more attributes of each project using a machine learning model; and
program instructions to update a knowledge base with the one or more attributes identified.

19. The computer system of claim 18, wherein analyzing the one or more project related documents for the set of previous projects of the user according to the common schema to identify the one or more attributes of each project using the machine learning model further comprises:
program instructions to parse the one or more project related documents for the set of previous projects using a rule-based approach with a set of pre-defined rules;
program instructions to extract one or more attributes of the project from the one or more project related documents for the set of previous projects;
program instructions to determine whether an attribute was not extracted from the project related documents from the one or more previous projects of the user;
responsive to determining the attribute was not extracted from the project related documents from the one or more previous projects of the user, program instructions to highlight the attribute not extracted from the project related documents from the one or more previous projects of the user; and
program instructions to enable the user to add the attribute not extracted from the one or more documents related to the project.

20. The computer system of claim 16, wherein predicting the outcome of the project using machine learning further comprises:
program instructions to output a predicted outcome of the project to the user;
program instructions to enable the user to review the predicted outcome of the project;
program instructions to enable the user to simulate a plurality of what-if scenarios by modifying one or more project parameters through an interaction with the digital profile to find a project configuration that optimizes a level of success of the project and that lowers a level of risk of the project; and
responsive to the user modifying the one or more project parameters, program instructions to update the predicted outcome of the project, including the set of measures indicating the success factor, the quality factor, and the risk factor of the project.
